(19) United States
(12) Patent Application Publication
(10) Pub. No.: US 2002/0032779 A1
(43) Pub. Date: Mar. 14, 2002

(54) Method and system for segment registration

(76) Inventors: Hsiang Tsun Yen, Taipei (TW); Chien Sen Weng, Taipei (TW); Luke Taylor, Taipei (TW)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/814,522

(22) Filed: Mar. 21, 2001

(30) Foreign Application Priority Data
Sep. 14, 2000 (TW) 089119021

(51) Int. Cl. G06F 15/16

(52) U.S. Cl. 709/227; 709/203

(57) ABSTRACT

A method and a system for segment registration use servers and clients on the Internet. The server includes a plurality of registration web pages and a registration file. The registration file includes a plurality of registration conditions and each condition corresponds to a registration request. After the client downloads the registration file, it initiates registration by continuously sending instructions via a browser interface. Based on the registration file downloaded from the server, the client then decides whether the instruction sent satisfies its corresponding condition and proceeds to the next step, sending a corresponding registration request to the server. Upon receiving the registration request, provided the registration request is complete, the execution of the instruction continues. If not, the server sends a registration web page responding to the registration request to the client. Only after the registration conditions are met in full can the instruction be continued.

### RELATED APPLICATIONS

This application claims the benefit of priority under 35 U.S.C. §119(a) of Taiwan Patent Application No. 089119021, filed Sep. 14, 2000.

### BACKGROUND OF THE INVENTION

1. Field of the Invention

The present invention relates to user registration, and more particularly to methods and systems for segment registration.

2. Description of the Related Art

Registration is the most frequent way used by Internet service providers to verify users' identities. In the past, a written registration procedure provided a form that required such personal data as name, sex and contact information. Marketing data, such as occupation and income range, might also be required. If the registration involves a transaction, the required information may also include identity card number, credit card number and related certification information.

The registration forms are filed after registrants fill them out. Despite the advent of the Internet, registration procedures have remained essentially unchanged with the minor difference being that the written form registration has now been largely replaced by the computer user interface registration. The registration records are now stored in an electronic storage medium. However, this registration procedure can cause inconvenience since the registrant may have to enter irrelevant and/or extraneous personal information in order to log onto a web site. Furthermore, due to the large number of web sites, registration tasks can take up a significant part of the registrant's time to complete. Additionally, the registrant may enter invalid information to log onto a web site, thereby failing to successfully register.

FIG. 1 illustrates a typical registration user interface which includes such requested data fields as real name, daytime phone number, nighttime phone number, e-mail account, password and confirmation of password, sex, date of birth, resident address and occupation. Where the registration request is associated with an online transaction, the registration user interface is even more complicated. In addition to the above requested data, the required data may further include credit card number, valid date of credit card and identity card number.

Currently, a number of software packages offer various wizards and objects wherein the users can follow a step-by-step approach and select among various options by clicking and thereby creating the user interface required. FIG. 1 illustrates such an interface. The interface in FIG. 1 can be created using, for example, Visual Basic Script, Java Script or ASP (Active server page). The links between the databases and data fields can be formed and translated by means of ADO (ActiveX Data Object), RDO (Remote Data Object) or DAO (Data Access Object). Databases can include, for example, Microsoft Structured Query Language database (“MS SQL”), Oracle database, and others.

FIG. 2 illustrates the registration data storage method. Each entry (i.e., row) corresponds to a specific user, and each column of the row corresponds to the requested field in the registration interface respectively as shown in the FIG. 1. When a new registrant makes a registration request, a new interface, as shown in FIG. 1, is created and a new entry in the database as shown in FIG. 2 is initiated. Accordingly, the same data that the registrant fills out is stored in the respective corresponding columns of the database in FIG. 2 as the registrant fills out the requested fields in the registration interface in FIG. 1. The registration process is completed when the registrant completes all the fields. Thereafter, when related data is required at the issue of an instruction from the registrant, it is retrieved from the corresponding column in the registrant's entry in the database.

Moreover, in order to ensure data security, some web sites require an ECA (Electric Certificate Authority) from users or request that the users register in person. The intent of the web site operators requiring such complicated registration procedures is to provide a safer and more comprehensive service. However, from a user's perspective, web sites seem to offer much more than the user truly needs. For example, a user may merely want to make a private account balance inquiry, but the process required to log onto the web site is based on the requirements for a possible on-line transaction. This results in an over-inclusive and exhaustive registration process for the user. Moreover, in certain other situations, a user may only wish to modify the data fields rather than to register as a new user. In such circumstances, both the user's time and the data storage capacity are inefficiently utilized by the using a single, generic form.

### SUMMARY OF THE INVENTION

In view of the inadequacies in the prior art registration method, the present invention provides a method and a system for segment registration. The invention aims to break up the single-form registration into segments. When an instruction issued by the client to the server requires personal registration data, the server sends a request to the client for the personal registration data actually required to carry out the client instruction. Upon receipt of the required personal data from the client, the server executes the client instruction and stores the data to carry out future client instructions requiring the same personal data. This avoids the inadequacy of the prior art registration method in requesting and storing all personal registration data in single-form without regard to the need of any particular data contained therein.

In a preferred embodiment of the method and the system for segment registration, the server in a client-server environment receives a plurality of instructions from the client and responds by offering a corresponding registration service. The server comprises a plurality of registration web pages and a registration file, which comprises a plurality of registration conditions, each corresponding to a registration request. The client downloads the registration file including registration conditions from the server. Provided the instruction satisfies its corresponding registration condition, the registration process proceeds to the next step by sending a corresponding registration request to the server.

When the server receives the corresponding registration request, it analyzes the request against the client database to verify whether the registration request is complete and contains all of the required data. If the registration request is complete, the server retrieves the registration record stored on the database and continues to execute the instruction. If the registration request is not complete, the server sends a registration web page responding to the registration request to the client or links the client to the registration web page by a hyperlink. The registration web page contains only the registration information required to carry out the client instruction. After the client enters the requested registration data and returns the registration web page to the server, the server stores the registration record in the database and executes the client instruction.

The client can issue instructions and download registration files from the server with a browser interface that can be provided by the server. The instructions to be issued by the client are preset into the registration web pages by the server.

Alternatively, instructions issued by the client can be verified by the server to determine whether they satisfy the registration conditions. If the server determines that the client instructions do satisfy the registration conditions, the server sends a registration web page to the client or links the client to the registration web page by a hyperlink. Thus, the client does not have to download the registration file from the server to make determinations regarding the instructions it issued to the server.

In a preferred embodiment, the server stores the required data based on the browsing habits of the clients. For example, the server does not store any client data if the client browses web pages only. However, the server requests the client to enter client contact address if the client requests to join promotion activities and requests to receive gifts therefrom. In another example, the server will store the client data when the client engages in online transactions. On such occasions, the server records the related credit card information after the transaction is completed. Thereafter, the server can retrieve the stored data when the same client initiates another online transaction on the same web site. Therefore, the server does not have to repeat the data request and the data recording process. For example, in an online transaction, instead of requesting and thereafter storing a detailed, single registration form, the server requests and stores just the registration information required to carry out the specific given client instruction. This helps to save data storage space and eliminates the inconvenience to clients of having to go through a detailed and long registration process.

### BRIEF OF THE DESCRIPTION OF THE DRAWINGS

These and other aspect of the present invention will be described below in connection with the drawings, in which:

FIG. 1 illustrates a user interface for registration in accordance with prior art;

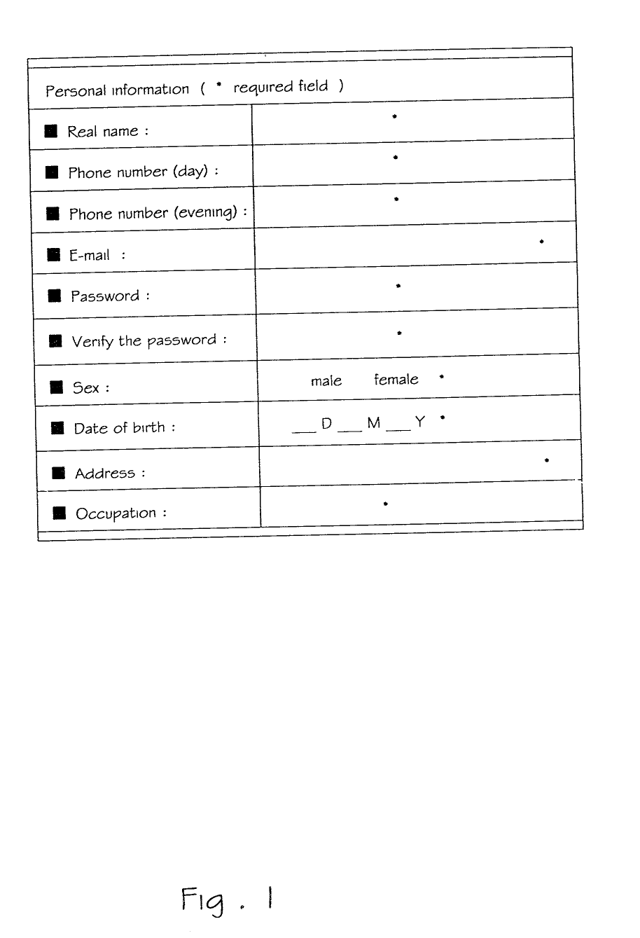

FIG. 2 illustrates a registration data storage method in accordance with prior art;

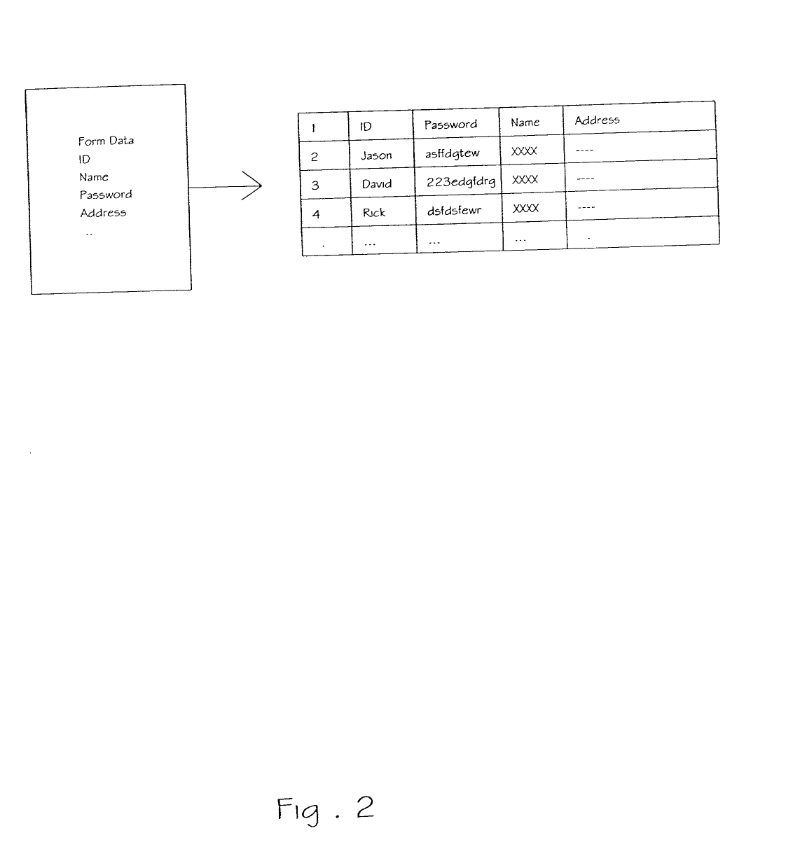

FIG. 3 illustrates a block diagram of the segment registration system according to a preferred embodiment of the invention;

FIG. 4 illustrates a structure of a registration file according to a preferred embodiment of the invention;

FIG. 5 illustrates a flow chart of the segment registration method according to a preferred embodiment of the invention;

FIG. 6 illustrates a block diagram of the segment registration system according to another preferred embodiment of the invention; and

FIG. 7 illustrates a flow chart of the segment registration method according to another preferred embodiment of the invention.

### DETAILED DESCRIPTION OF PREFERRED EMBODIMENTS

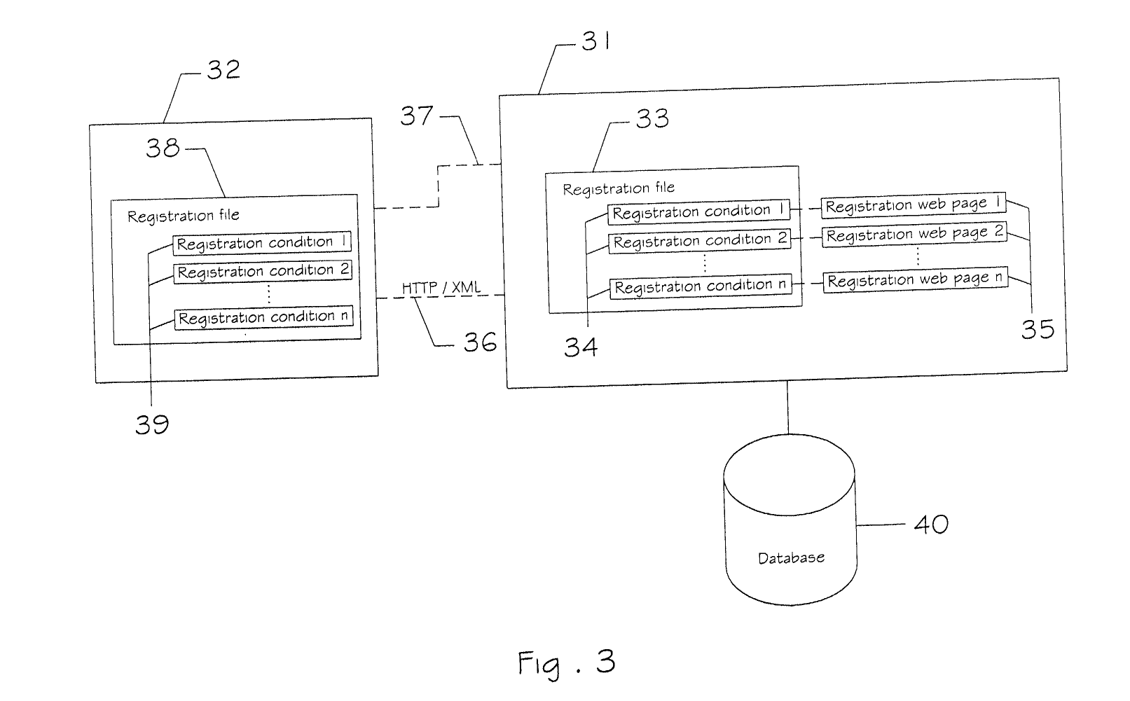

Two preferred embodiments of the present invention are described below in connection with FIGS. 3-7.

First Embodiment

When a user (i.e., the client), issues instructions to the server, preset rules are responsible for maintaining the following interactions. Upon receiving an instruction issued by the client, the server searches and determines whether the required specific data is available in the server database. If the data is not available, the server sends a hyperlink to the client and links the client to a registration web page which collects the exact required registration data. The client then completes the registration web page and returns the web page to the server. Upon receipt from the client, the server stores the registration data in the server database.

FIG. 3 illustrates a block diagram of the segment registration system according to a preferred embodiment. The system comprises a server 31 and a client 32. The server includes a registration file 33 and a plurality of registration web pages 35. The registration file 33 includes a plurality of registration conditions 34, each corresponding to said plurality of registration web pages 35. The client 32 requests a download of a registration file 33 through an HTTP/XML protocol 36. Thereafter, the registration file 33 is downloaded from the server 31 through a FTP protocol 37 to the client to be stored in the client as the registration file 38 which is identical to the registration file 33 at the server 31.

When the instructions issued by the client 32 through the HTTP/XML protocol 36 satisfy any of the registration conditions 39 in the registration file 38, the registration file 38 makes a request through the HTTP/XML protocol 36 to the server 31 to execute a corresponding registration web page 35. Firstly, the corresponding registration web page 35 verifies whether the client 32 has the corresponding registration information pertaining to the registration condition 39 in the database 40. If the registration information exists in the database 40, the required registration information is retrieved and the instruction issued by the client 32 is executed. Otherwise, the corresponding registration web page 35 is downloaded to the client 32 through the FTP protocol 37 or linked to the client 32 through the HTTP/XML protocol 36.

After the client 32 completes the corresponding registration web page 35 required by the instruction and informs the server 31 of registration completion through the HTTP/XML protocol 36, the server 31 then records the registration data included on the registration web page 35 onto the database 40. Concurrently, the server executes the client instruction. After the first registration, the required registration data can be retrieved directly from the database 40 without repeating the inquiry or the registration process the next time the client 32 issues the same instruction.

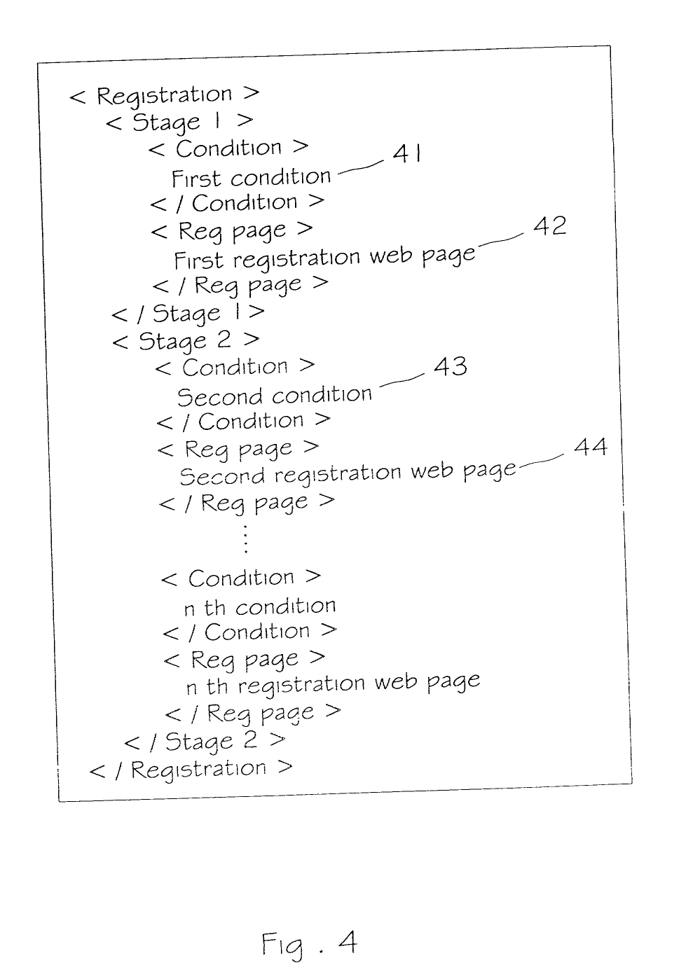

FIG. 4 illustrates the structure of a registration file 33 or 38. The registration file is an XML (Extensible Markup Language) document. As shown in FIG. 3, the client 32 requests the download of the registration file 33 through the HTTP/XML protocol 36. Following that request, the registration file 33 is downloaded from the server 31 to the client 32 through the FTP protocol 37. As shown in FIG. 4, when an instruction issued by the client satisfies the first registration condition 41, the client downloads or links to the first registration web page 42 to permit the client to complete the registration data field arranged therein. Similarly, when an instruction issued by the client satisfies the second registration condition 43, the client downloads the second registration web page 44 to permit the client to complete the registration data fields arranged therein. The number of registration conditions to be satisfied is subject to and determined by system design. Furthermore, the corresponding registration web page is set to verify whether the required registration data is already stored in the database, thereby avoiding the redundant and the repetitious registration process.

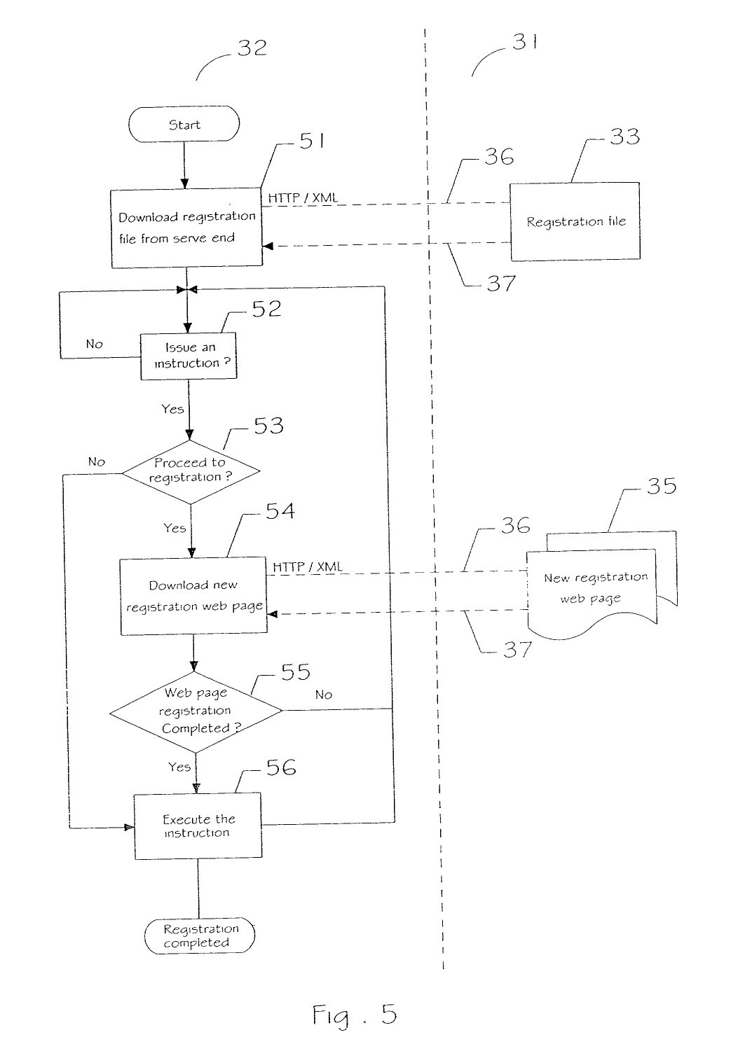

FIG. 5 illustrates a flow chart of the operation of the preferred embodiment depicted in FIG. 3. At a step 51, the client 32 submits a request to download a registration file 33 through the HTTP/XML protocol 36 whereupon the registration file 33 is downloaded from the server 31 to the client 32. At a step 52, the registration file 33 at the client 32, determines whether the client 32 issued any instructions. If it is determined that the client issued instructions, the control flows to a step 53.

At the step 53, a determination is made as to whether the instructions issued by the client satisfy a plurality of registration conditions 39. If the client instructions do satisfy the registration conditions shown in the FIG. 4 as registration conditions 41 or 43, the control flows to a step 54. At the step 54, the client 32 downloads the registration web pages 35 corresponding to registration conditions 41 or 43 from the server 31. At a step 55, the client 32 completes all required registration data fields on the registration web pages 35 and completes the registration. Upon completion of the registration web pages, the instructions issued by the client 32 are executed at the step 56.

On the other hand, if the instructions do not satisfy a plurality of registration conditions 39, for example, instructions issued are not relevant to the registration; the control then flows to 56 to execute the client's instructions.

Moreover, at the step 53, an inquiry can be made to determine whether the required registration data is stored in database 40 at the server 31. If it is determined that the required registration data is already stored in the database, the control flows to a step 56 to execute the client's instructions. By first determining whether the required registration data already exists in the database before proceeding to registration, redundant registration is bypassed.

The above described preset rules are subject to the demands and the design of the system. The preset rules can be incorporated at the server 31 or at the client 32. If the preset rules are incorporated at the client 32, the client determines whether the registration conditions 34 are satisfied. However, the server 31 retains the duty to offer a registration file for downloading to each client 32. After the registration file 33 is downloaded through a browser or an alternative interface to the client 32, the client determines whether the instruction it issued satisfies the registration conditions contained therein. Incorporating the preset rules at the client 32 helps to reduce the workload of the server 31. The preferred embodiment describes the situation where the preset rules are incorporated at the client 32.

If the preset rules are incorporated at the server 31, the client 32 issues instructions via a browser or an alternative interface. The server 31 first determines whether the instructions issued by the client 32 satisfy the registration conditions 34 and then sends or provides a hyperlink to the corresponding registration web page to the client 32. The alternative preferred embodiment discussion that follows describes the situation where the preset rules are incorporated at the server 31.

Alternative Preferred Embodiment

In the alternative preferred embodiment, the server 31 primarily determines whether the instruction issued by the client 32 through the HTTP/XML protocol 36 satisfies the registration conditions 34, thereby avoiding the need for the client 32 to download the registration file 33 from the server 31.

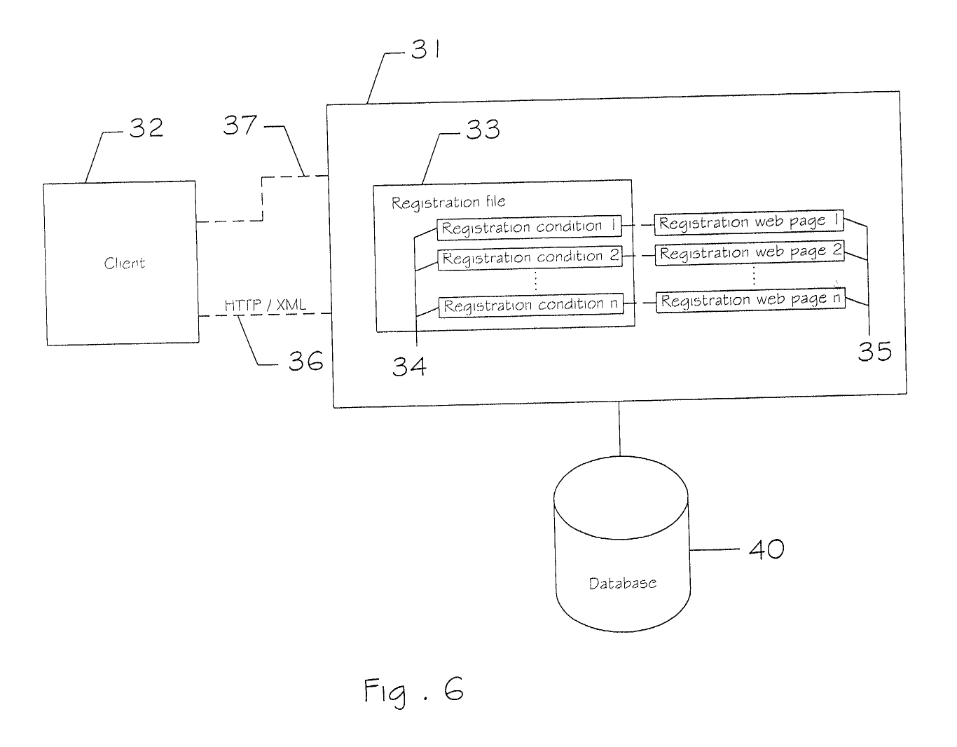

FIG. 6 illustrates a block diagram of the segment registration system according to an alternative preferred embodiment. The alternative preferred embodiment comprises a server 31 and a client 32. The server includes a registration file 33 and a plurality of registration web pages 35. The registration file 33 includes a plurality of registration conditions 34, each corresponding to a plurality of registration web pages 35. As shown in FIG. 6, the client 32 does not have to download a registration file 33 through the HTTP/XML protocol 36. The client 32 issues instructions to the server 31 continuously through the HTTP/XML protocol 36. When the instructions issued by the client 32 satisfy any of the registration conditions 34 at the server 31, the corresponding registration web page 35 verifies whether the required registration data for the specific client 32, corresponding to registration condition 34, is available in the database 40. If the registration data exists in the database 40, the required registration data is retrieved and the instruction issued by the client 32 is executed. Otherwise, the registration web page 35 is downloaded to the client 32 through the FTP protocol 37 or is linked to the client 32 through the HTTP/XML protocol 36.

After the client 32 completes the registration data required by the instruction and informs the server 31 of registration completion through the HTTP/XML protocol 36, the server 31 then records the registration data on the registration web page corresponding to the client 32 onto the database 40 and simultaneously executes the instruction. The next time the client 32 issues the same instruction, the required registration data can be directly retrieved from the database 40 without repeating the inquiry or the registration process.

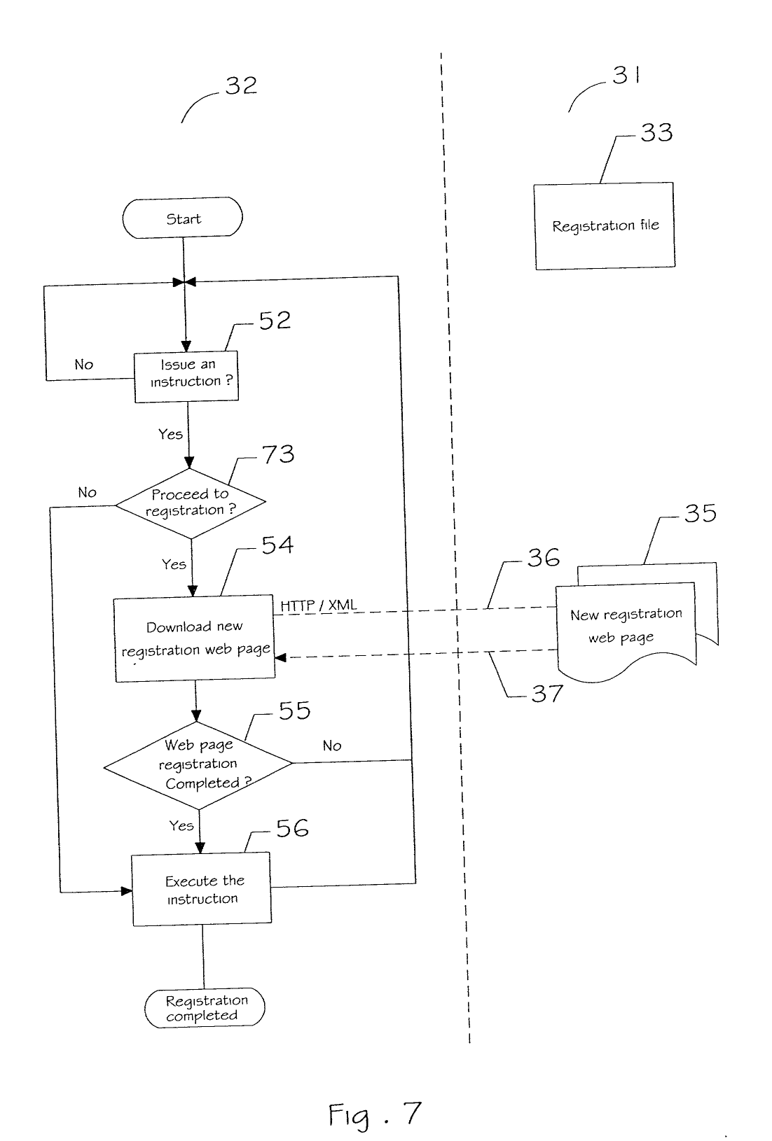

FIG. 7 illustrates a flow chart of the segment registration method according to an alternative preferred embodiment depicted in FIG. 6. At a step 52, the server 31 continues to monitor whether the client 32 issues any instructions.

At a step 73, the server 31 determines whether the instructions issued by the client 32 satisfy a plurality of registration conditions 34 of the registration file 33. If the client instructions do satisfy any of the registration conditions 34, the control flows to a step 54. At the step 54, the client 32 downloads from the server 31 hyperlinks to the registration web page 35 corresponding to the registration conditions 41 or 43. At a step 55, the client 32 completes all required registration data fields on the registration web page 35 and completes the registration. Upon completion of the registration web page, the instructions issued by the client 32 are executed at the step 56.

On the other hand, if the instructions do not satisfy a plurality of registration conditions 34, for example, instructions issued are not relevant to the registration; the control then flows to 56 to execute the client's instructions.

Moreover, at the step 53, an inquiry can be made to determine whether the required registration data is stored in database 40 at the server 31. If it is determined that the required registration data is already stored in the database, the control flows to a step 56 to execute the client's instructions. By first determining whether the required registration data already exists in the database before proceeding to registration, redundant registration is bypassed.

In the above-described preferred embodiments, the client 32 issues instructions via a browser or an alternative interface (neither shown in the diagrams). Every instruction is preset at the server 31, which also offers the browser interface used by the client 32. By clicking on titles or icons on the interface, the client 32 issues instructions.

At the server 31, the database 40 only contains the required registration data from the client 32. The preferred embodiments enable a more flexible registration process between interactions, such as online transactions between the server 31 and the client 32. The server 31 stores only the required registration data so that the client 32 does not have to complete an over-inclusive, single-form registration in advance. In addition, the data storage use is maximized by avoiding the need to store unnecessary and extraneous data.

Although this invention has been described in terms of certain preferred embodiments, other embodiments that are apparent to those of ordinary skill in the art are also within the scope of this invention. Accordingly, the scope of the present invention is intended to be defined only by reference to the appended claims.

What is claimed is:

1. A segment registration method, used for a client-server architecture having a server and a client, wherein said server comprises a plurality of registration web pages and a plurality of registration conditions corresponding to said registration web pages, said registration method comprising:
sending a first request from said client to said server;
receiving said first request, said server responding by sending said registration conditions to said client to enable said client to continue sending instructions to said server via a user interface;
sending a second request from said client to said server if said instructions sent by said client to said server satisfy any of said registration conditions;
receiving the second request from said client, said server responding by sending corresponding registration web pages to said client;
receiving said registration web pages from said server, said client incorporating a registration record into said registration web pages and responding by sending said registration record to said server;
receiving said registration record from said client, said server storing said registration record thereby; and
completing said registration at said server.

2. The segment registration method according to claim 1, further comprising verifying the completion of said second request.

3. A segment registration method according to claim 1, further comprising retrieving said registration record from said server to continue said instructions.

4. A segment registration method according to claim 1, wherein said user interface is a browser interface.

5. A segment registration method according to claim 1, wherein said user interface is provided by said server.

6. A segment registration method according to claim 1, wherein said instructions to be issued by the client are preset by the server.

7. A segment registration method according to claim 1, wherein said instructions sent by said client are executed by clicking a computer mouse, or other input facility.

8. A segment registration method, used for a client-server architecture having a server and a client, wherein said server comprises a plurality of registration web pages and a plurality of registration conditions corresponding to said registration web pages, said registration method comprising:
sending instructions from said client to said server via a user interface satisfying said registration conditions;
sending said corresponding registration web pages from said server to said client;
receiving said registration web pages from said server to said client;
incorporating a registration record into said registration web pages at said client;
sending said registration record to said server;
receiving and storing said registration record from said client; and
completing said registration at said server.

9. A segment registration method according to claim 8, further comprising verifying the completion of said instruction.

10. A segment registration method according to claim 8, further comprising retrieving said registration record from said server to continue the execution of instructions.

11. A segment registration method according to claim 8, wherein said user interface is a browser interface.

12. A segment registration method according to claim 8, wherein said user interface is provided by said server.

13. A segment registration method according to claim 8, wherein said instructions to be issued by client are preset by the server.

14. A segment registration method according to claim 8, wherein said instructions directed by said client are executed by clicking a computer mouse and other input facility.

15. A segment registration system, comprising:
a server comprising a plurality of registration web pages and a plurality of registration conditions that correspond to said registration web pages; and
a client that downloads a plurality of registration conditions corresponding to its instructions and determines whether to respond to corresponding registration requests to said server based on said registration conditions;
wherein said server receives said registration requests and thereafter verifies the completion of registration, said server responding to completion of said registration, indicating the completion of said instructions, said server responding to lack of completion of said registration by sending said registration web pages to said client, whereupon said client incorporating a registration record into said registration web pages, said server responding by continuing to execute said instructions.

16. A segment registration system according to claim 15, wherein said client further comprises a user interface, which is used for sending said instructions.

17. A segment registration system according to claim 16, wherein said user interface is a browser interface.

18. A segment registration system according to claim 16, wherein said user interface is provided by said server.

19. A segment registration system according to claim 15, wherein said instructions to be issued by client are preset at the server.

20. A segment registration system according to claim 15, wherein said instructions directed by said client are executed by clicking a computer mouse or other input facilities.

21. A segment registration system comprising:
a server comprising a plurality of registration web pages and a plurality of registration conditions that correspond to said registration web pages; and
a client, wherein said client continues to send instructions to said server;
wherein if said instructions issued by said client satisfy said registration conditions preset by the client, then an inquiry is sent to said client to ask whether said client completed said registration, said client responding to said server with yes or no, said server responding to yes from said client by continuing to execute said instructions, said server responding to no from said client by sending said registration web pages to said client, said client receiving said registration web pages, incorporating a registration record into said registration web pages, and returning said registration web pages to said server as instructions to be executed by said server.

22. A segment registration system according to claim 21, wherein said client further comprises a user interface, which is used for sending said instructions.

23. A segment registration system according to claim 22, wherein said user interface is a browser interface.

24. A segment registration system according to claim 22, wherein said user interface is provided by said server.

25. A segment registration system according to claim 21, wherein said instructions to be issued by client are preset by the server.

26. A segment registration system according to claim 21, wherein said instructions directed by said client are executed by clicking a computer mouse and other input facilities.

27. A segment registration server comprising:
a plurality of registration web pages;
a plurality of registration conditions that correspond to said registration web pages; and
an interface that receives instructions from a client, said server responsive to said instructions from said client to determine whether said instructions satisfy said registration conditions, said server responsive to said instructions satisfying said registration conditions to send an inquiry to said client to ask whether said client completed said registration, said server responsive to a reply of yes received from said client to continue to execute said instructions, said server responsive to a reply of no from said client to send said registration web pages to said client, said server receiving said registration web pages from said client with a registration record incorporated therein, said server executing instructions in response to said registration web pages with said registration record therein.
